(19) United States
(12) Patent Application Publication
(10) Pub. No.: US 2004/0111931 A1
(43) Pub. Date: Jun. 17, 2004

(54) Protector for vehicle license plates

(75) Inventor: John H. Lee, Olathe, KS (US)

Correspondence Address: John H. Lee, 1441 N Lucy Montgomery Way, Olathe, KS, 66061, US

(73) Assignee: Rigel Technology Corporation, Shawnee, KS

(21) Appl. No.: 10/318,941

(22) Filed: Dec. 16, 2002

(51) Int. Cl. G09F 7/00

(52) U.S. Cl. 40/200

(57) ABSTRACT

A practical method for protecting a vehicle license plate from being stolen is provided. The vehicle license plate protector comprises two parts. The first part has two functions. It has the screws at one end, which can be screwed onto the vehicle body through the existing location and screw holders, and the connection at another end. The second part has the connection against the connection end on the first part. The second part is pushed into the first part and connected with the first part. The second part holds the vehicle license plate firmly. Then the vehicle license plate can not be taken away by normal methods. The cost for the vehicle license plate protector may be less than one dollar, which provides a practical and economical protection for automobile industry and vehicle customers to protect vehicle license plates.

### BACKGROUND OF THE INVENTION

This present invention relates to a practical method for a vehicle license plate protection at very low cost by a protector with two parts. The first part, which has screws at one end and a connection at another end, is screwed onto the vehicle body with the existing screw holders. The second part, which has a connection at one end, is pushed through the existing holes on an existing vehicle license plate. It is connected with the first part each other for protecting the vehicle license plate, which can not be token out with a screw driver.

Vehicle license plates are mounted to the vehicle bodies by two or four screws currently. There are four holes, which are about 9/32 inch diameter, on the vehicle license plates. The screws are past through the holes on the vehicle license plates and screwed onto the vehicle bodies with the screw holders. The screws are also very easy to be taken out with a screw driver.

Several U.S. patents relating vehicle license plates have been issued over years. U.S. Pat. No. 6,264,393 discloses a connection element having an upper piece attachment to the plate element and a lower piece connectable with the support. An intermediate region is provided between the upper piece and the lower piece. A cast part surrounds the intermediate region above the support. Also a sealing element is between the casting part and the embeddable contact piece engaging a surface of the support. The same author has also developed an intermateable holding element and plate member including elastic holding element mounting region, which is described in U.S. Pat. No. 6,254,302. In one form, the elastic region includes a holding zone. In another form, the elastic region is formed by a pair of elongate resilient arms that disposed on opposite sides of the elastic region. U.S. Pat. No. 5,845,584 discloses a bridge plate assembly for use in moving vehicles between rail cars for loading and unloading has sufficient length to span the space between adjacent rail cars and has sufficient width to accommodate vehicles of varying wheelbase. U.S. Pat. No. 5,428,911 discloses a mountable display apparatus for surrounding the edges of a vehicle identification plate mounted within the plate well of a vehicle. The frame is flexible and larger than the plate well. U.S. Pat. No. 5,150,960 discloses a vehicle illumination device for a license plate that includes a frame enclosing a clear plastic wedge which serves as a light pipe for a light source placed along one edge of the clear plastic wedge. U.S. Pat. No. 4,4924,611 discloses a frame comprising upper, lower, and side bars outlines a space to display a license plate. U.S. Pat. No. 4,813,167 discloses an apparatus for removably fastening a cover plate to cover a vehicle's existing license plate. When a cover plate for a license plate is so mounted, it is placed in an overlying relation with respect to the license plate. U.S. Pat. No. 4,001,822 discloses an electronic license plate including a single antenna system.

Vehicle license plates are easily screwed onto the vehicle bodies with the existing screw holders currently. The screws are also very easy to be taken out with a screw driver. The license plates are stolen easily, which happen in public parking lots and at night time. It gives inconvenience to the vehicle owners and drivers after it happens. There is a need to have a protection for vehicle license plates. Also the cost should be low enough for people to use the protection for their vehicle license plates.

### DESCRIPTION OF THE INVENTION

The present invention provides a practical and economical protector to protect vehicle license plates and the plate support or decoration plates. The plates can not be taken away by normal methods. When the vehicle license plates are needed to be changed, the areas around the holes on the vehicle license plates have to be removed, then the protector can be taken away by the screws.

The vehicle license plate protector comprises two parts. The first part has two functions. It has the screws at one end, which can be screwed onto the vehicle body through the existing location and screw holders, and the connection at another end. The second part has the connection against the connection end on the first part. The second part is placed through the plate into the first part and connected with the first part. The second part holds the vehicle license plate firmly. Then the second part can not be taken away from the first part by normal methods.

After the second part is placed into the first part, the connection couplings expand and connect with the first part. The connection between the first part and the second part can be released after the coupling connection by such as a press, spring or lock is released. So the vehicle license plate protector can be used again. If the vehicle license plate protector is to be used once, the release is not necessary.

When the protector is used, the screw end of the first part is screwed onto the vehicle body through the existing screw holders in the vehicle license plate location. A wide screw driver or a double-heads screw driver-liked tool is used to screw the first part onto the vehicle body. A vehicle license plate with existing two or four holes is placed onto the plate location. Then the second part is placed through the holes. One end of the second part holds the vehicle license plate. The holding end has larger diameter than the holes of the vehicle license plate. Another connection end is connected with the first part of the vehicle license plate protector. The plate is held firmly. When an additional decoration or support plate and a vehicle license plate are used, the second part with little longer length is used for holding the both plates. If the diameter on the additional decoration or support plate has larger diameter than the second part diameter, the additional decoration or support plate can be reused.

When the vehicle license plate is changed, the area around the holes on the vehicle license plate must be cut by a metal scissors to make the holes larger than the diameter of the second part of the vehicle license plate protector. For new vehicle license plates, the punched lines around the holes on the vehicle license plate may be made by the manufacturers. Then it is easy to remove the around area according to the punched lines, which does not need a metal scissors. After removing the area around the holes on the vehicle license plate, the vehicle license plate can be removed easily. The vehicle license plate is only used once. After the plate change, the old license plate can not be used again because the hole area has been destroyed. After removing the old license plate, the vehicle license plate protector is screwed out from the first part of the vehicle license plate protector. The diameter of the connection end of the first part is larger than the diameter of the holding end of the second part. The second part is still attached to the first part of the vehicle license plate protector. The vehicle license plate protector may be used once. The vehicle license plate protector may also be used again when the second part is released from the first part.

The cost for a vehicle license plate protector may be less than one dollar, which provides a practical and economical protection for automobile industry and vehicle customers to protect vehicle license plates.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

A vehicle license plate protector comprised two parts. The first part with screws at one end and a connection at another end was screwed onto a vehicle body through the existing vehicle license plate location and the existing screw holder. The second part was pushed through an existing hole on a vehicle license plate into the first part of the vehicle license plate protector. The second part was connected with the connection end of the first part each other. The vehicle license plate was held by the vehicle license plate protector. The end of the second part on the surface of the vehicle license plate could not be taken away from the first part of the protector and the vehicle body with a screw driver. The vehicle license plate was protected by the vehicle license plate protector.

### EXAMPLE 2

For changing a vehicle license plate, the area around the holes on the vehicle license plate was cut with a metal scissors to make the holes larger than the diameter of the second part of the vehicle license plate protector. After removing the area around the holes on the vehicle license plate, the vehicle license plate was removed. The vehicle license plate protector was screwed out from the vehicle body by the end of the first part of the vehicle license plate protector. Another vehicle license plate protector comprised two parts. The first part with screws at one end and a connection at another end was screwed onto the vehicle body through the existing vehicle license plate location and the existing screw holder. The second part was pushed through an existing hole on a vehicle license plate into the first part of the vehicle license plate protector. The second part was connected with the connection end of the first part each other. The vehicle license plate was held by the vehicle license plate protector.

What is claimed is:

1. A method of protecting a vehicle license plate by a protector with two parts comprising to screw the first part onto a vehicle body with the screw holder and to connect the second part through the existing holes on the vehicle license plate with the first part for protecting the plate from being stolen.

2. The method of claim 1 wherein the first part has one end with the screws and another end with a connection for the second part.

3. The method of claim 1 wherein the second part has one end to connect with the first part and another end to hold the vehicle license plate.

4. The method of claim 1 wherein the protector is not screwed out without removing the area around the existing holds of the vehicle license plate.

5. The method of claim 1 wherein the connection between the first part and second part is not released for using the protector once.

6. The method of claim 1 wherein the connection between the first part and second part is released for reusing the protector more than one time.

7. The method of claim 1 wherein the existing location and screw holders for the vehicle license plate is used for the protector.

8. A protection product for a vehicle license plate is produced according to the method of claim 1.

9. A method of protecting a vehicle license plate with the punched lines around the existing hole area on a vehicle license plate by a protector with two parts comprising to screw the first part onto a vehicle body with the screw holder and to connect the second part through the existing holes on the vehicle license plate with the first part for protecting the plate from being stolen.

10. The method of claim 9 wherein the punched area around the holes on the vehicle license plate is removed before screwing out the protector.

11. A vehicle license plate product with the punched lines around the existing holes on the vehicle license plate is produced according to method of claim 9.

12. A method of protecting a plate by a protector with two parts comprising to screw the first part onto a support body with the screw holder and to connect the second part through the holes on the plate with the first part for protecting the plate from being stolen.

13. The method of claim 12 wherein the first part has one end with the screws and another end with a connection for the second part.

14. The method of claim 12 wherein the second part has one end to connect with the first part and another end to hold the plate.

15. The method of claim 12 wherein the connection between the first part and second part is not released for using the protector once.

16. The method of claim 12 wherein the connection between the first part and second part is released for reusing the protector more than one time.

17. A protection product for a plate is produced according to the method of claim 12.
